(19) United States
(12) Patent Application Publication
(10) Pub. No.: US 2011/0225502 A1
(43) Pub. Date: Sep. 15, 2011

(54) Accessing web services and presenting web content according to user specifications

(76) Inventors: Grant BlahaErath, Redmond, WA (US); Paul Scarpa, Kirkland, WA (US); Dragan Popovich, Bellevue, WA (US)

(21) Appl. No.: 13/065,131

(22) Filed: Mar. 14, 2011

Related U.S. Application Data
(60) Provisional application No. 61/340,341, filed on Mar. 15, 2010.

(51) Int. Cl. G06F 3/048; G06F 15/173

(52) U.S. Cl. 715/739; 709/223; 709/224; 715/781

(57) ABSTRACT

A way for enabling a user to discover, present, save and share Web content is disclosed. A user is provided a means of executing searches across Web services, as well as for saving those searches for later use. An embodiment of the method and system employs the use of a Transmuter to display Web media in a format deemed optimal by the user. Users are also provided a means of saving references to Web content on their device, as well as posting those references along with certain annotations using Web services.

### RELATED APPLICATIONS

This application claims priority to provisional application 61/340,341, filed Mar. 15, 2010.

### FIELD

The instant application relates to networked client/server systems and to methods of discovering, presenting, saving and sharing Web content, or more generally, any content available over a network, in such systems. More particularly, the instant application relates to posting and consuming content to Web services, or more generally, any network services, using standard protocols.

### BACKGROUND

The Internet Web browser started a revolution in the way people consumed entertainment and information. Since then, we have seen nearly every aspect of our lives impacted; from how we shop to the way we get news to how we socialize. Simple web pages have given way to rich Web experiences where watching, playing and interacting online have become as common as reading. However, for all the change in the way people use the Internet, very little has changed with respect to the HTML browser itself. Commercially available browsers look similar to one another and function in a similar way. They often include a URL address bar where a user can type in the address of a Web site they want to visit, a main display window where documents are rendered from the interpretation of HTML over HTTP, and some form of feature to save URL links locally for later retrieval by the user.

### SUMMARY

The instant application describes ways to enable a Web user to discover, present, consume, save and share Web content. Current browsers are not fully optimized around the three main activities that the typical Web user performs, namely i) searching for data or content they want to find; ii) viewing the data or content they found (including reading, listening to music, watching photos and videos); and iii) saving not only the URL link to an HTML document but also a comprehensive set of data about the context and relevance of the content being marked for archival. The user is provided a means of executing searches across various Web services, and for saving those searches for later use. In one implementation, the content may be transmuted to be displayed in a format deemed optimal by the user. The user is also provided a means to save references to Web content on their device, and to post those references, along with certain annotations, using various Web services. One skilled in the art will recognize that various types of Web content may be searched across many different Web services, that various types of content may be transmuted into various formats to appear optimal to the user, and that various types of references to Web content may be saved in various locations or posted using many different Web services.

### BRIEF DESCRIPTION OF THE DRAWINGS

These and other features and advantages of the way for accessing Web services and presenting Web content according to user specifications will now be described with reference to drawings of certain embodiments, which are intended to illustrate and not to limit the instant application:

FIG. 1a shows an embodiment of a client/server system and environment for accessing Web services and presenting Web content according to user specifications;

FIG. 1b shows an example of a logical block diagram of the modules of the software;

FIG. 2 shows an example of a Canonical Web Service Element;

FIG. 3a shows an example of a flow diagram illustrating data exchanges between various modules of the software;

FIG. 3b shows another example of a flow diagram illustrating data exchanges between various modules of the software;

FIG. 4a shows an example of a Feed Web Service Module;

FIG. 4b shows an example of a Provider Element of the Feed Web Service Module;

FIG. 4c shows an example of a Post Web Service Module;

FIG. 4d shows an example of an Item Element of the Post Web Service Module;

FIG. 5 shows an example of a graphical user interface (GUI) for accessing Web services and presenting Web content according to user specifications;

FIG. 6a shows an example of one view of a Discovery window of the GUI;

FIG. 6b shows an example of a minimized view of the Discovery window of the GUI;

FIG. 6c shows an example of a quick search mode of the search pane of the Discovery window of the GUI;

FIG. 6d shows an example of an advanced search mode of the search pane of the Discovery window of the GUI;

FIG. 6e shows an example of another possible view of the Discovery window of the GUI;

FIG. 7 shows an example of a View window of the GUI;

FIG. 8a shows an example of one view of a Post window of the GUI;

FIG. 8b shows an example of a minimized view of the Post window of the GUI;

FIG. 8c shows an example of a post service pane of the Post window of the GUI;

FIG. 8d shows an example of a book service pane of the Post window of the GUI;

FIG. 9a shows an example of a Ready window of the GUI;

FIG. 9b shows an example of a minimized view of the Ready window of the GUI; and

FIG. 10 shows an example of a component diagram of a computing device.

### DETAILED DESCRIPTION

Reference will now be made in detail to embodiments of the instant application, examples of which are illustrated in the accompanying drawings. Whenever possible, the same reference numbers will be used throughout the drawings to refer to the same or like parts.

Although discussed in reference to certain illustrations, the instant application is not limited to those illustrations. In particular, many of the aspects and features of the instant application are most easily understood by those skilled in the art when conveyed as functions of a user interface. Those skilled in the art should appreciate that the user interface illustrations are examples, and that the instant application is not limited to the user interface features specifically discussed herein.

In the discussion below, the instant application will be described in the general context of computer-executable instructions, such as program modules, being executed by one or more conventional personal computers or other computing devices. Generally, program modules include routines, programs, objects, components, data structures, and the like that perform particular tasks or implement particular abstract data types. Moreover, those skilled in the art will appreciate that the instant application may be practiced with other computer system configurations, including, but not limited to, video game consoles, TV sets, TV set-top boxes, video disc players, personal video recorders, smart phones, pocket computers, tablets and other touch-enabled devices, hand-held devices, multiprocessor systems, microprocessor-based or programmable consumer electronics, network PCs, minicomputers, and mainframe computers. In a distributed computer environment, program modules may be located in both local and remote memory storage devices.

For purposes of illustration, programs and other executable program components such as the operating system are illustrated herein as discrete blocks, although it is recognized that such programs and components reside at various times in different storage components of the computer, and are executed by the data processor(s) of the computer.

The instant application describes ways to enable a Web user to discover, present, consume, save and share Web content. Current browsers are not fully optimized around the three main activities that the typical Web user performs, namely i) searching for data or content they want to find; ii) viewing the data or content they found (including reading, listening to music, watching photos and videos); and iii) saving not only the URL link to an HTML document but also a comprehensive set of data about the context and relevance of the content being marked for archival. The user is provided a means of executing searches across various Web services, and for saving those searches for later use. A Web service is software designed to support interoperable machine-to-machine interaction over a network. In one embodiment the content may be located on the Web; however those skilled in the art should recognize that the content may be located on the Internet or on any suitable network. The network is hereinafter defined as one or more computers configured to communicate with one or more other computers.

In one implementation, the content may be transmuted to be displayed in a format deemed optimal by the user. The user is also provided a means to save references to Web content on their device, and to post those references, along with certain annotations, using various Web services. One skilled in the art will recognize that various types of Web content may be searched across many different Web services, that various types of Web content may be transmuted into various formats to appear optimal to the user, and that various types of references to Web media content may be saved in various locations or posted using many different Web services.

### 1. SYSTEM ARCHITECTURE

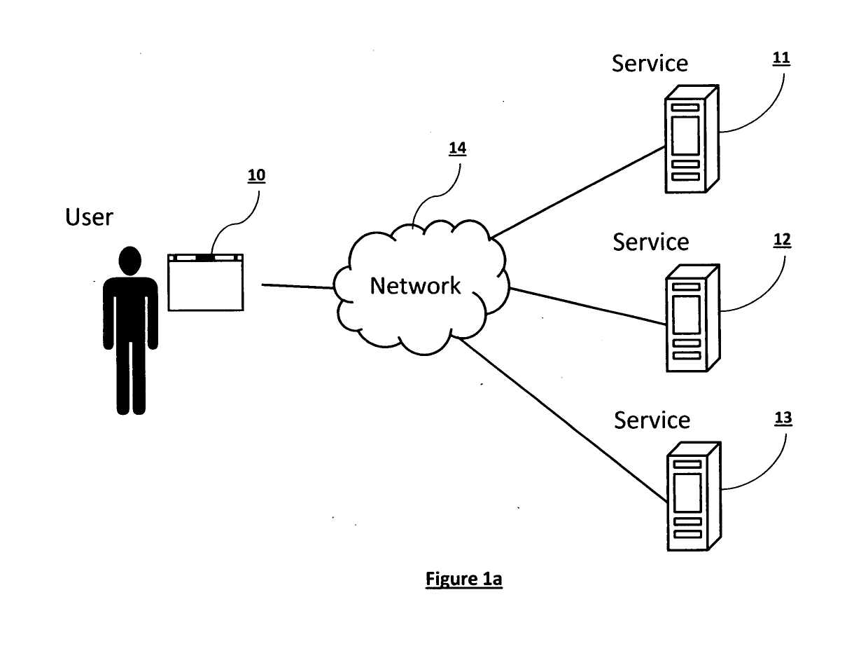

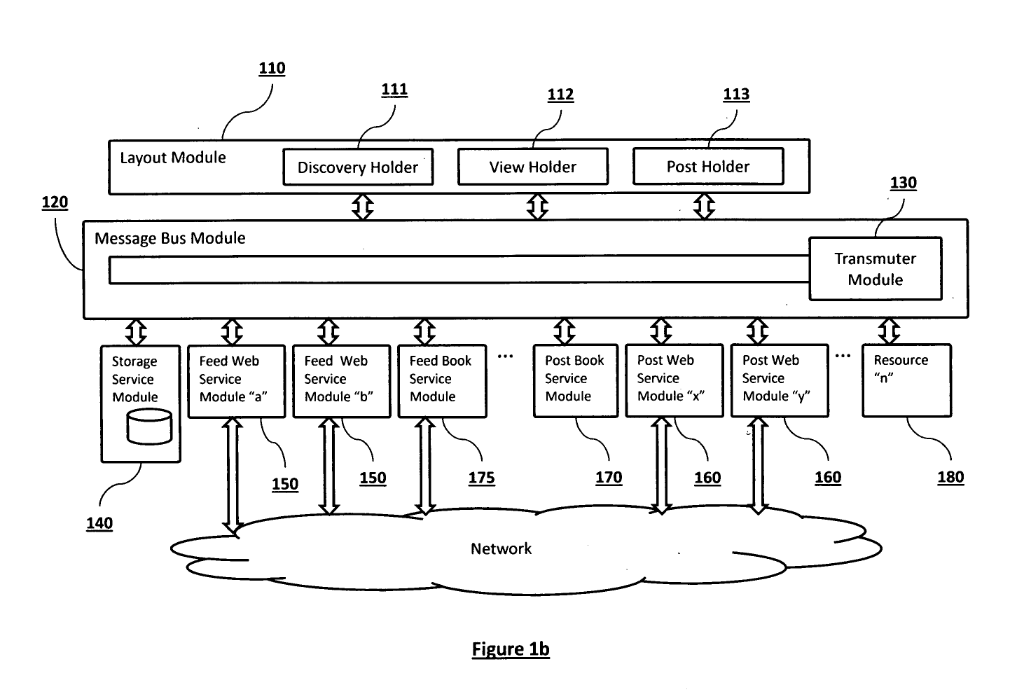

FIG. 1a shows an example of a client/server system and environment in accordance with one embodiment of the instant application. The user may interact with a client device 10, which is used to access data and content that is provided via Web Services made available by other server computers 11, 12, and 13 that reside on a data communications network 14 such as the Internet, a local-area network, a private wide-area network, or any combination thereof.

A Web service is software designed to support interoperable machine-to-machine interaction over a network, such as the ability to search for or present specific forms of Web content, via application programming interfaces (APIs) rather than graphical user interfaces. The Web service may do this by using a variety of communication protocols (such as, but not limited to, SOAP, REST, SMPT, SSL, and HTTP) and data formats (such as, but not limited to, XML, JSON, and HTML) that may allow clients and servers to negotiate with each other over the data communication network. Unlike traditional client/server models, such as a Web server/Web page system, Web services may not provide the user with a graphical user interface (GUI). Web services may instead share business logic, data and processes through a programmatic interface across a network.

It will be appreciated by those skilled in the art that the computing environment illustrated in FIG. 1a is but one example, and a wide variety of computer and network configurations may be used without departing from the spirit of the instant application. For instance, the client computer may be any of a wide variety of computing devices, including, but not limited to: desktop computer, laptop computer, personal digital assistant, or mobile handset. Furthermore, although in the examples provided herein, the software is shown as a running on a client computer, in another embodiment of the instant application the software may reside and execute on a content provider server or a server under the control of a content provider, on the a single computer, or on some combination of multiple computers.

For purposes of illustration, software programs and other executable program components such as the operating system are illustrated herein as logical blocks, although it is recognized that such programs and components may reside at various times in different storage components of the computer, and are may be executed by the data processor(s) of the computer. In one embodiment of the instant application, software may be composed of software Modules, which manage specific functions in the software. In some instances, these software Modules may be tailored to the specific requirements of one or several Web services. These Web Service Modules may be composed of Web Service Elements that manage certain functions in relation to their interaction with the associated Web Services.

FIG. 1b shows an example of a logical block diagram of software modules according to an embodiment of the instant application. A module is a component that may contain zero or more Web service elements, zero or more feed service elements, zero or more post service elements, and zero or more Transmuters. A Feed Service Module may be implemented as a Feed Web Service Module, i.e. a module that manages interaction with Feed Web Services, or as a Feed Book Service Module, i.e. a module that manages interaction with computer storage media on a local device. A Post Service Module may be implemented as a Post Web Service Module, i.e. a module that manages interaction with Post Web Services, or as a Post Book Service Module, i.e. a module that manages interaction with computer storage media on the local device.

Also on FIG. 1b, one embodiment of the software may consist of a Layout Module 110 that controls the interface between a user and software's various other modules, a Message Bus Module 120 which manages the communications of the software, a Transmuter Module 130 which performs inline manipulation of content, a Storage Service Module 140 which manages the storage of data specific to the software, one or more Feed Web Service Modules 150 that manage interaction with Feed Web Services, one or more Post Web Service Modules 160 that manage interaction with Post Web Services, a Post Book Service Module 170, an instance of the Post Web Service Module 160 that saves data to a local device, rather than posting it to an external Web Service, a Feed Book Service Module 175, an instance of the Feed Web Service Module 150 that searches data on the local device, rather than searching for it on an external Web Service, and one or more Resources 180 that may be external to the software and are used to display content and interact with the user.

Also on FIG. 1b, one embodiment of software may include the Layout Module 110 that controls the interface between a user and the software's various modules. The Layout Module 110 may consist of a Discovery Holder Module 111 that controls the presentation of search data, a View Holder Module 112 that controls the presentation of view data, and a Post Holder Module 113 that controls the presentation of post data. The Layout Module is primarily responsible for the optimal display of the GUI to the user depending on the constraints or capabilities of their computing device. For instance, if the user were using a mobile phone or similar device with limited display characteristics, the Layout Module may scale down the interface for use of the software on that device. Similarly, if the device is touch-enabled or pen-based, the Layout Module may enable certain interface features (like touch swiping to navigate lists) or disable certain features (such as mouse hover behaviors). Similarly, if the device is voice-enabled, the Layout Module may enable voice commands to interact with the GUI. According to one implementation of the instant application, the markup of the user interface may be represented in XAML, a version of XML supported by Microsoft™.NET™ and Windows Presentation Foundation™ platform.

Also on FIG. 1b, one embodiment of software may include the Message Bus Module 120 which manages the communication between modules within the software. The Message Bus Module may provide mechanism for synchronous and asynchronous communication between modules as well as dynamic marshaling of messages across execution, memory and communication boundaries. The Message Bus Module 120 may insulate modules from each other to decrease module interdependency and permit the later introduction of modules into an existing architecture. The Message Bus Module 120 may also support message types with attributes for unicasting, multicasting and bidirectional casting.

Also on FIG. 1b, one embodiment of software may include the Transmuter Module 130 which monitors messages traveling across the Message Bus Module 120 and, based on the logic in a chaining rule engine, may optionally intercept, manipulate, or create new messages. The Transmuter Module 130 may convert and adapt data, may redirect messages from the intended destination, and may mask the source of the messages from the recipient.

Also on FIG. 1b, one embodiment of software may include the Storage Module 140 which manages storage of data specific to the software. The Storage Module 140 may include a data repository management logic component for managing a data repository on a local device or a data repository made available via its own Web Service. Accordingly, as the software receives input or data from the user or the Web Service, the data repository management logic component may store this data into computer storage media. Similarly, the data repository management logic component may recall data from the computer storage media, and provide it to a corresponding software module so that the data may be viewed or manipulated. According to one implementation of the instant application, the Storage Module 140 may use for computer storage media SQL Compact™, a lightweight relational database product available from Microsoft Corporation™.

Also on FIG. 1b, one embodiment of the software may include one or more Feed Web Service Modules 150 to manage interaction with Feed Web Services. The Feed Web Service is a service that may allow searching for content. The Feed Web Service may accept data from a requester via some protocol (such as, but not limited to, XML over SOAP and JSON over SSL) and return data to the requester in some predefined format (such as, but not limited to, XML and JSON). For instance, if the user is interested in finding a list of video assets online relevant to a particular topic, the user may specify a keyword search and the service to be searched via the user interface to the Feed Web Service Module. The Feed Web Service Module may return to the user interface a list of results matching the search as provided by the Feed Web Service searched. The Feed Web Service Modules may be associated with various Feed Web Services, such as general-purpose search engines (such as, but not limited to, Bing™ and Google™), shopping services (such as, but not limited to, Amazon™ and eBay™), video-sharing services (such as, but not limited to, YouTube™ and Hulu™), news services (such as, but not limited to, New York Times™ and Wall Street Journal™), social networks (such as, but not limited to, Facebook™ and LinkedIn™), a blog or a microblogging service (such as, but not limited to, Twitter™ or another service that may use short messages), or any other service that may allow search for content.

Also on FIG. 1b, one embodiment of the software may include one or more Post Web Service Modules 160 to manage interaction with Post Web Services. The Post Web Service may accept data from a requester via some protocol (such as, but not limited to, XML over SOAP and JSON over SSL) and may perform an action on behalf of the requester, such as, but not limited to, sending a communication over a network. For instance, if the user is interested in posting a remark regarding a video asset discovered online, the user may select a particular Post Service (such as, but not limited to, email, social network, blog, microblogging service, or another communication network), type a remark, attach an HTTP URL to the video asset, and send it to the network service provider. The Post Service Module may then save a copy of that remark, along with all of its associated data, and submit the remark and URL to the relevant Web Service for display, transmission or further processing on the communication network.

Also on FIG. 1b, one embodiment of the software may include one or more Resources 180 used to display content or interact with a user. The Resources are Modules that may provide certain capabilities, such as the ability to render an HTML Web page, display an Adobe™ Flash™ video, play a MPEG3 audio file, or present other digital file formats commonly used by Web Service Modules. For instance, if two Feed Web Service Modules need to display a Web page, they may each use a shared Web Browser Resource Module to display the content. According to one implementation of the instant application, Resource Modules may include Microsoft™ Internet Explorer™ Web browser, Adobe™ Flash™ video player, reader software, and MP3 player software.

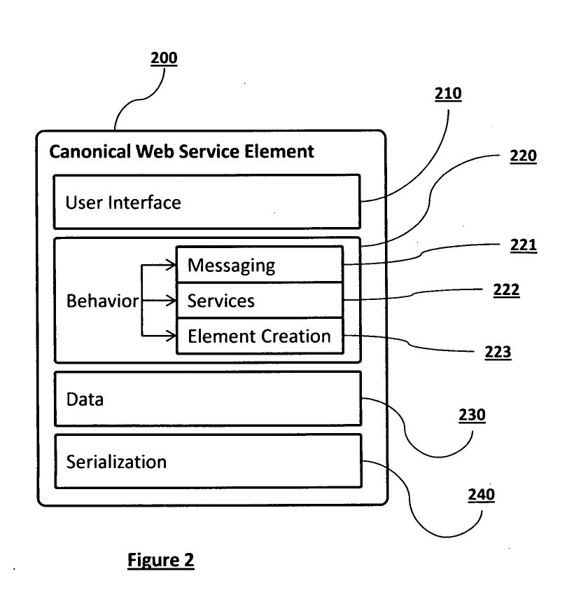

FIG. 2 shows an example of a logical block diagram of a Canonical Web Service Element 200 used by software. The Canonical Web Service Element 200 is a component that may consist of a User Interface (UI) Logic component 210 that manages the interaction between a user and the software, a Behavior Logic component 220 that manages how the software should respond to user requests, a Data Structure component 230 that is used to structure the data provided by the user or associated Web Service(s), and a Serialization Logic component 240 that manages how the software stores data related to the associated Web Service(s) for later retrieval. The Canonical Web Service Elements may interact with each and other mechanisms of the software via the Message Bus Module 120.

Also on FIG. 2, in one embodiment the Behavior Logic component 220 may consist of a Messaging Behavior Logic component 221 that manages the Canonical Web Service Element's 200 communications with software and its associated Web Services over the network, a Service Behavior Logic component 222 that implements rules specific to the associated Web Services, such as how often to make requests of the service, and an Element Behavior Logic component 223 that manages the creation and destruction of Web Service Elements.

In one embodiment of the instant application, software may make use of two types of Web Service Modules, namely the Feed Web Service Module 150 that manages interaction with Feed Web Services, and the Post Web Service Module 160 that manages interaction with Post Web Services. It will be appreciated by those skilled in the art that these are but two examples of the wide variety of Web Service types, and that other types of Web Service Modules might be used without departing from the spirit of the instant application.

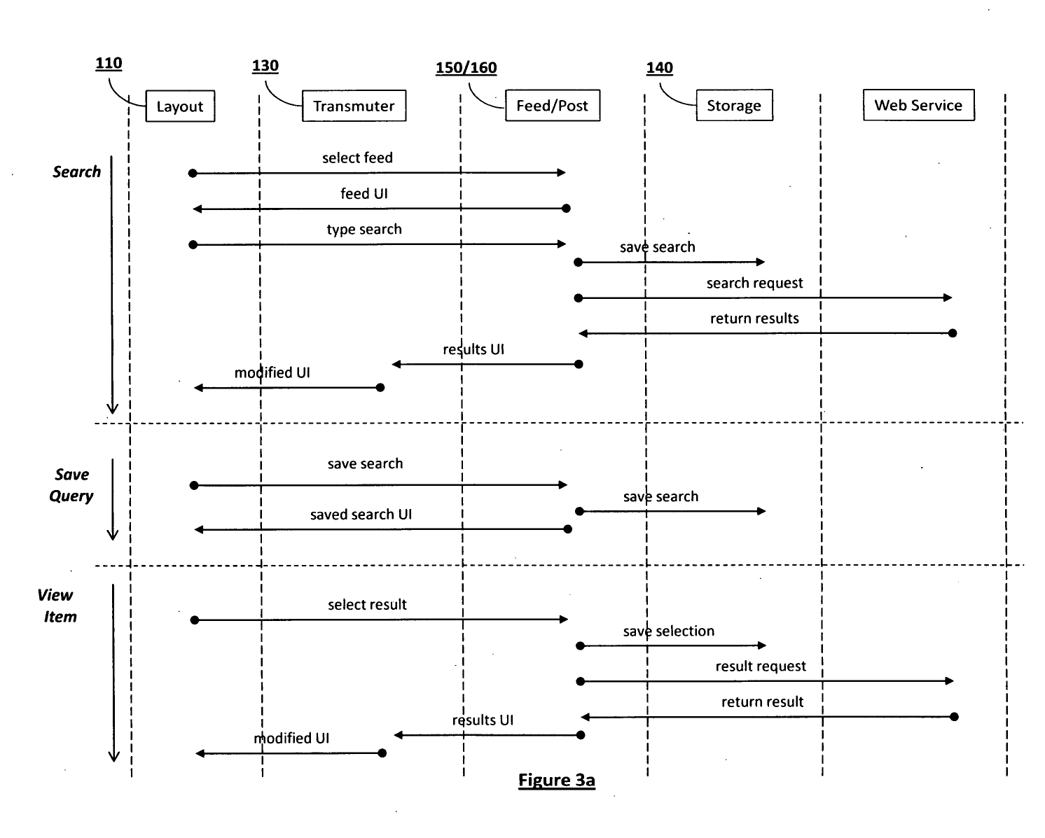

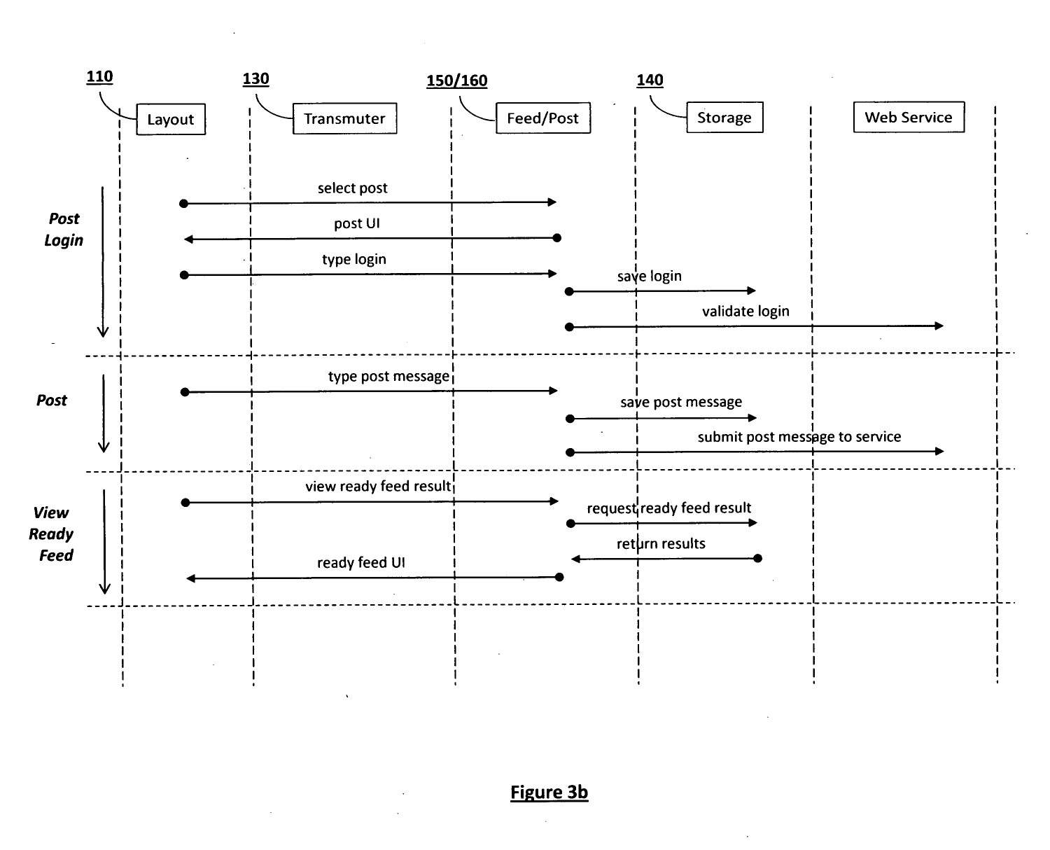

FIG. 3a shows an example of a flow diagram illustrating data exchanges between the Layout Module 110, the Transmuter Module 130, the Feed Web Service Module 150, the Post Web Service Module 160, the Storage Module 140, and associated Web Services. Other Modules of the embodiment are not shown in FIG. 3a to enhance the clarity of the explanation. It should be noted that the sequences of steps presented here are for illustrative purposes only; other step sequences may be used without departing from the spirit of the instant application.

The steps described in FIG. 3a show an example of a set of actions that may occur when a user initiates a search from the Feed Module 150. The user interacts with the Layout Module 110 to select from available Feed Web Services, and the Feed Web Service Module 150 presents an appropriate graphical user interface to the user. The user types and submits their search to the Feed Web Service Module 150, which in turn may save the request in the local storage via the Storage Module 140 and initiate a request of its associated Feed Web Services. The Feed Web Service may return results to the Feed Web Service Module 150, which are placed on the Message Bus Module 120. If the results are among those the Transmuter Module 130 is coded to modify, it may do so, reformatting the results and presenting them to the user in the Layout Module 110 thus fulfilling the user's request.

The steps described in FIG. 3a similarly show an example of a set of actions that may occur when a user saves a search to a local device via the Storage Module 140. The user saves the existing search via the Feed Web Service Module 150, which in turn may save the search to computer storage media via the Storage Module 140. The confirmation of the saved search may be returned to the user in the Layout Module 110 thus fulfilling the user's request.

The steps described in FIG. 3a also show an example of a set of actions that may occur when a user views an result, which may be a piece of content that the user found by searching. The user requests an result for presentation via the Layout Module 110, which submits the request to the Feed Web Service Module 150, which in turn may save the request in local storage via the Storage Module 140 and initiate a request of its associated Web Services. The Feed Web Service may return an result to the Feed Web Service Module 150, the details of which are placed on the Message Bus Module 120. If the result is of a type that the Transmuter Module 130 is coded to modify, it may do so, reformatting the result and presenting it to the user in the Layout Module 110 thus fulfilling the user's request.

FIG. 3b shows another example of a flow diagram illustrating data exchanges between the Layout Module 110, the Transmuter Module 130, the Feed Web Service Module 150, the Post Web Service Module 160, the Storage Module 140, and associated Web Services. Other Modules of the embodiment are not shown in FIG. 3b to enhance the clarity of the explanation. It should be noted that the sequences of steps presented here are for illustrative purposes only; other step sequences may be used without departing from the spirit of the instant application.

The steps described in FIG. 3b show an example of a set of actions that may occur when a user authenticates and then posts an result or remark using the Post Web Service Module 160. The user interacts with the Layout Module 110 to select from available Post Web Services, and the Post Web Service Module 160 presents an appropriate graphical user interface to the user. The user types and submits their login to the Post Web Service Module 160, which in turn may save the login to computer storage media via the Storage Module 140 and validate the login against its associated Web Service. The user types and submits their post message to the Post Web Service Module 160, which in turn may save the post message to the computer storage media via the Storage Module 140 and submit the post message to its associated Web Service.

The steps described in FIG. 3b also show an example of a set of actions that may occur when a user requests to view a ready feed result via the Storage Module 140. The user requests the existing ready feed result via the Feed Web Service Module 150, which in turn may pass the request to computer storage media via the Storage Module 140. The Storage Module 140 may return results to the Feed Web Service Module 150, which are placed on the Message Bus Module 120. The results are presented to the user in the Layout Module 110 thus fulfilling the user's request.

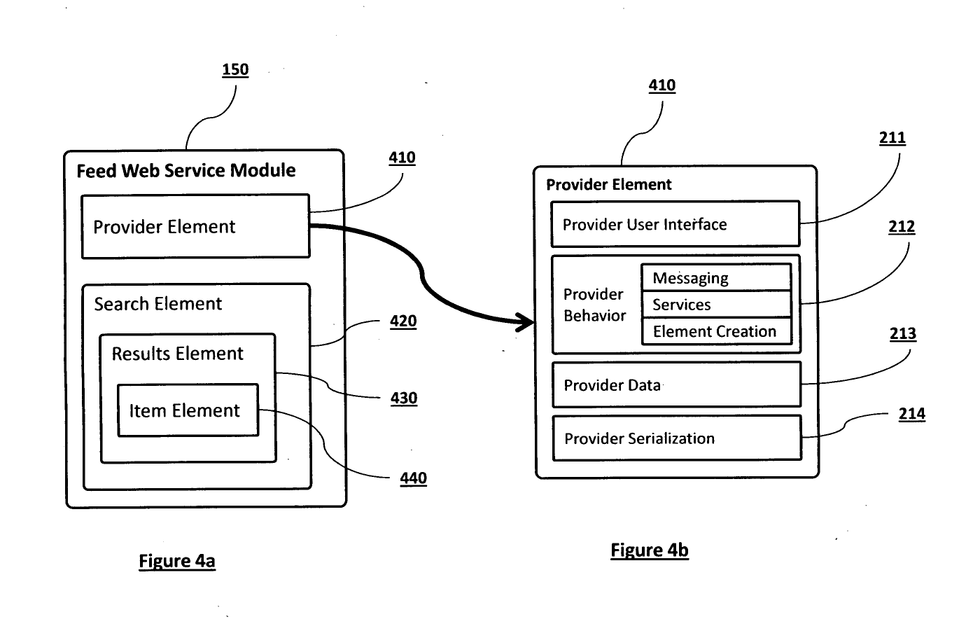

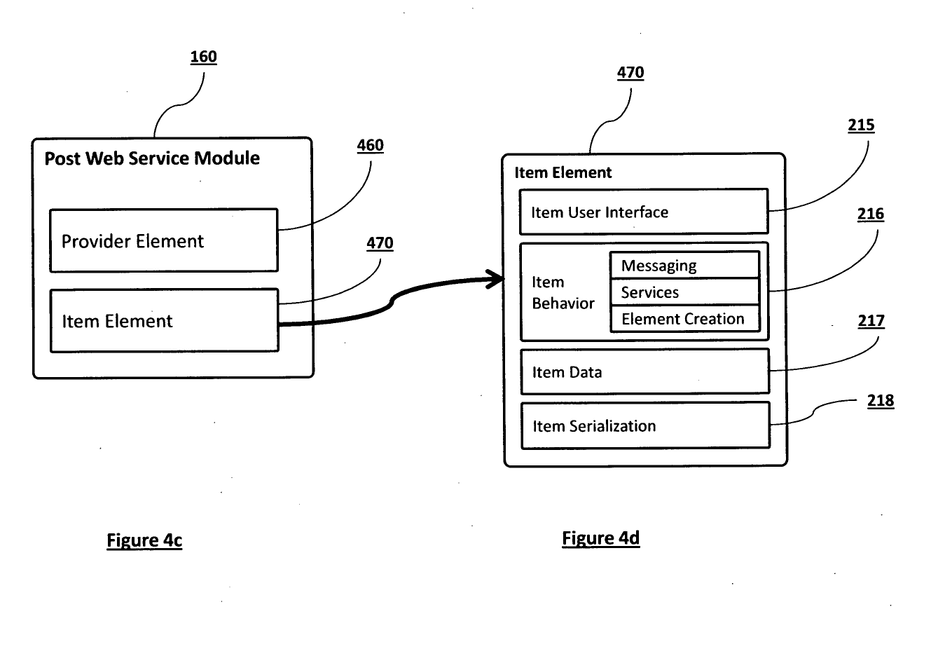

FIG. 4a shows an example of a logical block diagram of the Feed Web Service Module 150, a Web Service Module designed to manage interactions with associated Feed Web Services. In one embodiment of the instant application, the Feed Web Service Module 150 may consist of four types of Feed Web Service Elements to manage interactions with the associated Feed Web Services. The constituent Feed Web Service Elements are one or more Provider Elements 410, and one or more Search Elements 420 to collect user input (such as a keyword search). The Search Element 420 may consist of one or more Results Elements 430, and the Results Element 430 may consist of one or more Item Elements 440.

The constituent Feed Web Service Elements, i.e. the Provider Element 410, the Search Element 420, the Result Element 430, and the Item Element 440 may consist of the same building blocks as the Canonical Web Service Element 200 shown in FIG. 2.

FIG. 4b shows an example of the Provider Element 410 of the Feed Web Service Module 150. The Provider Element 410 may consist of a Provider User Interface Logic component 211, a Provider Behavior Logic component 212, a Provider Data Structure component 213, and a Provider Serialization Logic component 214. Other Feed Web Service Elements 420-440 also may consist of the same building blocks as the Canonical Web Service Element 200 shown in FIG. 2.

FIG. 4c shows an example of a logical block diagram of the Post Web Service Module 160, a Web Service Module designed to manage interactions with associated Post Web Services. In one embodiment of the instant application, the Post Web Service Module 160 may consist of two types of Post Web Service Elements to manage interactions with the associated Post Web Services. The constituent Post Web Service Elements are one or more Provider Elements 460 and one or more Item Elements 470.

The constituent Post Web Service Elements, i.e. the Provider Element 460 and the Item Element 470 may consist of the same building blocks as the Canonical Web Service Element 200 shown in FIG. 2.

FIG. 4d shows an example of the Item Element 470 of the Post Web Service Module 160. The Item Element 470 may consist of an Item User Interface Logic component 215, an Item Behavior Logic component 216, an Item Data Structure component 217, and an Item Serialization Logic component 218. The Provider Element 460 also may consist of the same building blocks as the Canonical Web Service Element 200 shown in FIG. 2.

It will be appreciated by those skilled in the art that there are many potential combinations of the user interface logic components, the behavior logic components, the data structure components, and the serialization logic components that may be used to compose the Web Service Elements, and in turn, many potential combinations of the Web Service Elements that may be used to compose the Web Service Modules, without departing from the spirit of the instant application.

### 2. GRAPHICAL USER INTERFACE

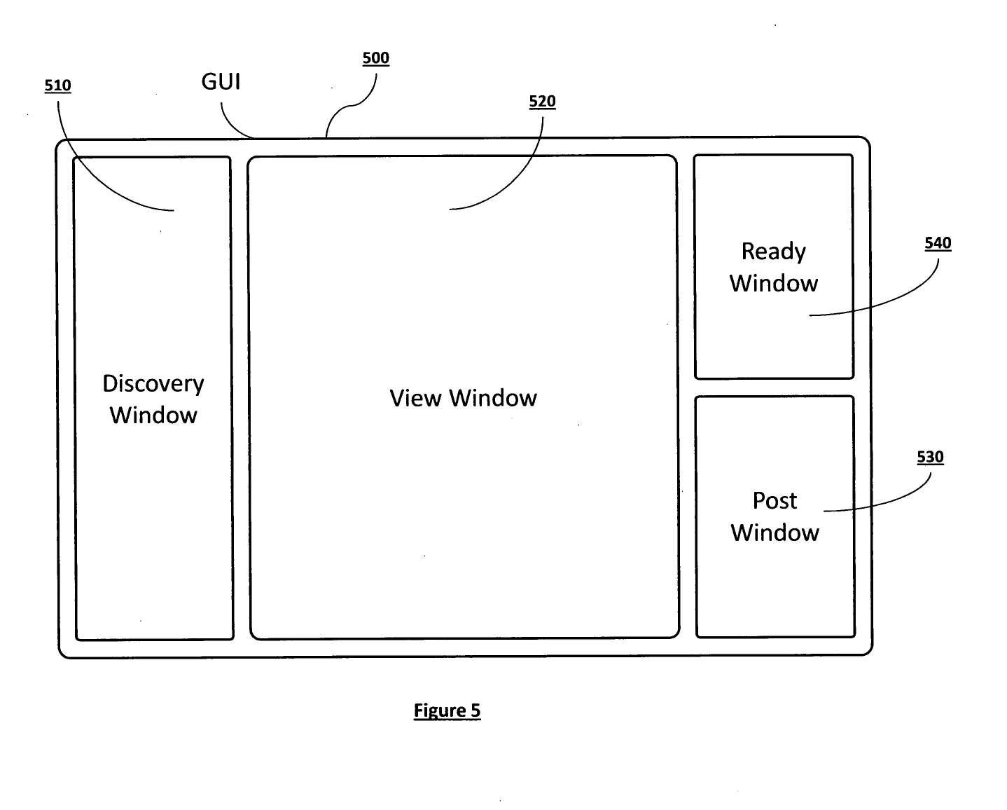

FIG. 5 shows an example of a graphical user interface (GUI) 500 of the system that concurrently displays user interface objects for the discovery, consumption, sharing and saving of the Web content. According to one embodiment of the instant application, the GUI 500 may consist of a Discovery window 510, a View window 520, a Post window 530, and a Ready window 540. The Discovery window 510 is a region of the GUI within which the user may create and may execute searches of Web Services for Web content, and where the user may evaluate the results from those searches. The View window 520 is a region of the GUI within which the user may view one or more results from the search in more detail. The Post window 530 is a region of the GUI within which the user may save a result for local storage, or may post a message to a Web service. The Ready window 540 is a region of the GUI within which the user may maintain a list of content results they access most frequently or have posted most recently.

Although FIG. 5 shows a horizontal arrangement of the windows of the GUI 500, with the Discovery window 510 at left, the Post window 530 at lower right, the Ready window 540 above the Post window, and View window 520 occupying the majority of the center of the display, it should be apparent to one skilled in the art that these windows may be arranged in other ways to optimize for the user's display device or individual preference. In another embodiment of the instant application, the windows may be arranged vertically (with the Discovery window 510 at top and the Post window 530 and Ready window 540 at bottom). In yet another embodiment of the instant application, the windows may be arranged in an overlapping manner, whereby the Discovery window 510 occupies the entire display, and other windows may be opened through a window selection control. A control is an element of user interface that may be configured to accept various inputs from a user, such as, but not limited to, a clickable button, a text box, a slider, a gesture, and a voice command.

### 3. USER INTERFACE FOR WEB CONTENT DISCOVERY

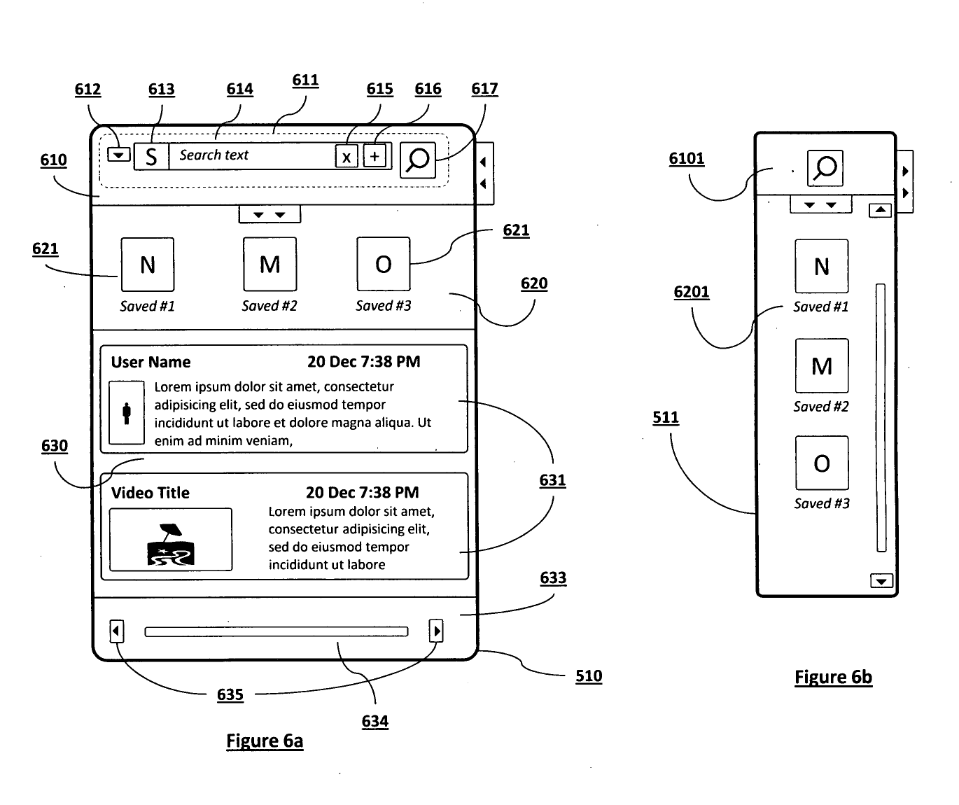

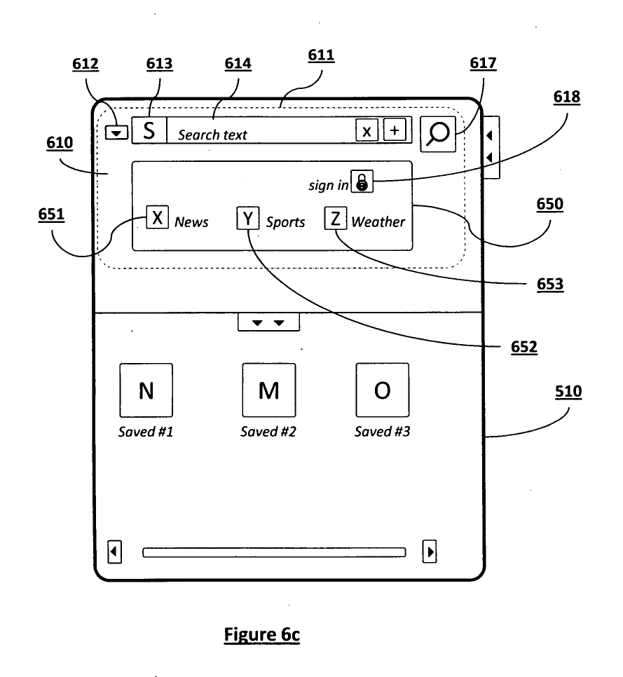

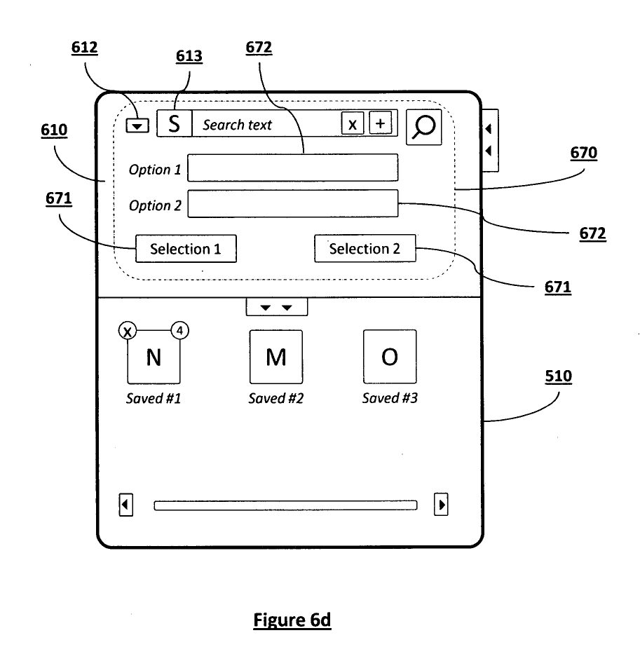

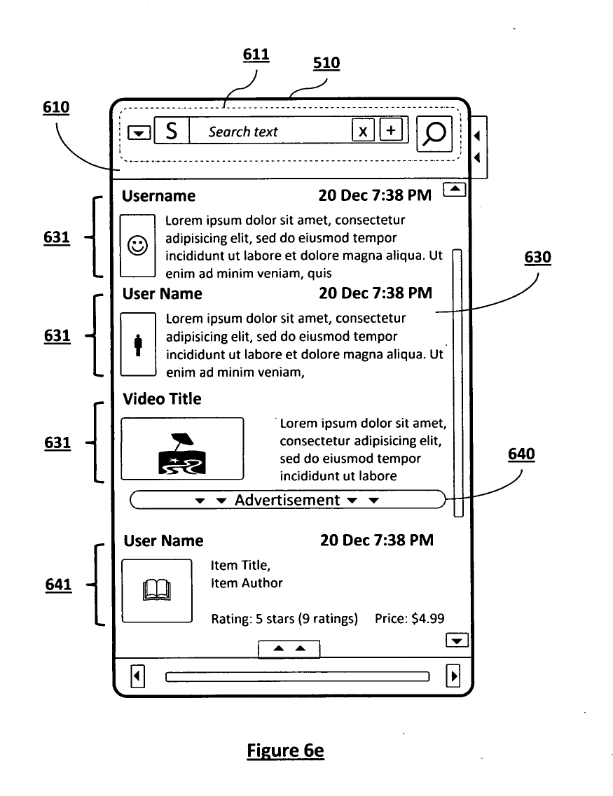

FIG. 6a shows an example of one embodiment of the Discovery window 510 in greater detail. The Discovery window 510 may provide controls for a user to compose a keyword search and may place that keyword search in form of a message via the Discovery Holder Module 111 on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. One or more Feed Web Service Modules 150 may take the transmuted message from the Message Bus Module 120 and may send it to one or more Feed Web Services. One or more Feed Web Services may respond with one or more results of the keyword search. One or more Feed Web Service Modules 150 may place those results in form of messages on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. The Discovery window 510 may take the transmuted messages via the Discovery Holder Module 111 from the Message Bus Module 120 and may display them as results of the keyword search, as described below.

In another embodiment, the Discovery window 510 may provide controls for a user to compose a keyword search and may place that keyword search in form of a message via the Discovery Holder Module 111 on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. The Feed Book Service Module 175 may take the transmuted message from the Message Bus Module 120 and may send it to the Storage Module 140. The Storage Module 140 may respond with one or more results of the keyword search and may place those results in form of messages on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. The Discovery window 510 may take the transmuted messages via the Discovery Holder Module 111 from the Message Bus Module 120 and may display them as results of the keyword search, as described below.

The Discovery window 510 may consist of a search pane 610, a saved search pane 620, and a search results pane 630. It should be noted that the sequences of steps presented herein are for illustrative purposes only; other step sequences may be used without departing from the spirit of the instant application.

The search pane 610 may have one or more modes; in one embodiment, there are two modes, a quick search mode and an advanced search mode. In one embodiment, the quick search mode may be the default mode of the search pane 610.

Also on FIG. 6a, the quick search mode 611 of the search pane 610 is shown according to one embodiment. The quick search mode 611 may consist of a mode selector button 612, a service selector button 613, a textbox 614, a clear textbox button 615, a save search button 616, and a search button 617. In one embodiment, the clear textbox button 615, and the save search button 616 may occupy the same space but do not have to appear at the same time; the clear textbox button 615 may appear by default and may be present while the textbox 614 is empty and while a user is entering keyword search text in the textbox 614. Clicking on the clear textbox button 615 may delete all text from the textbox 614. When the user has entered desired keyword search text into the textbox 614, the user may click the search button 617 to perform the search. Clicking on the save search button 616 may save this particular search for future use.

Also in FIG. 6a the saved search pane 620 of the Discovery window 510 is shown according to one embodiment. The saved search pane 620 may contain one or more saved search icons 621 that represent saved searches. When a user enters desired keyword search text into the textbox 614, the user may click the search button 617 to perform the search. In one embodiment, clicking on the save search button 616 may save this particular search for future use, and the saved search icon 621, consisting of a logo of the search service and a keyword, corresponding to that saved search, may appear in the saved search pane 620. When the user clicks on the saved search icon 621, that particular search may be re-run and an updated set of the search results 631 may appear in the results pane 630.

The search pane 610 may allow users to enter search keywords into the textbox 614. The service selection button 613 may allow users to select one or more Feed Web Services where they want to search using particular search keywords, where those services may be existing search engines (such as, but not limited to, Google™, Bing™, and Ask™), social networking sites (such as, but not limited to, Facebook™, MySpace™, and LinkedIn™), news sites (such as, but not limited to, New York Times™, Wall Street Journal™, and Bloomberg™), video sharing sites (such as, but not limited to, YouTube™ and Hulu™), blogs, microblogging services (such as, but not limited to, Twitter™ or another service that may use short messages), shopping web sites (such as, but not limited to, Amazon™ and eBay™), or any other web property or service where users can search for data. The quick search pane 610 also may allow the users to search for their recent posts, either those posted to any of the Post Web Services or to the Post Book Service.

Also in FIG. 6a the search results pane 630 is shown according to one embodiment. The search results pane 630 may consist of one or more individual search results 631, a navigation module 633, which may contain a slideshow play button 634, and other navigation buttons 635. The search results 631 may appear after a user performs keyword search. When the user clicks on the individual search result 631, content of that search may appear in the View window 520. Instead of clicking on the individual search results 631, using navigation module 633 may be an alternative method for navigating through individual search results 631.

FIG. 6b shows an example of a minimized view of the Discovery window 511 according to another embodiment. The minimized view of the Discovery window 511 may consist of a minimized view of the search pane 6101, and a minimized view of the saved search pane 6201.

FIG. 6c shows an example of the quick search mode 611 of the search pane 610 when the service selector button 613 is selected, according to one embodiment. The service selector button 613 in default mode may show an icon of a default search service, but a user may select other search services by clicking on the service selector button 613; a list of other search services 650 may open up in the search module 610, showing one or more buttons 651-653 for additional search services. Selecting any of these search service buttons 651-653 may change the service where the keyword search will be performed when the user performs the search. One or more of the search services 651-653 may require the user to sign in to perform a search (for example a subscription-only news service or a social networking web site), so a sign in to service button 618 may appear next to the respective search service that requires a sign in. A search may be performed on any of the available Feed Web Services or a Feed Book Service.

By selecting the sign in to service button 618, the user may be presented with a sign in window, whereby the user can enter their credentials for accessing search services.

FIG. 6d shows an example of the advanced search mode 670 of the search pane 610 according to one embodiment. The advanced search mode 670 may be accessed by selecting the mode selector button 612 of the search pane 610. Depending on which search service is selected using the service selector button 613, as explained above, the advanced search mode 670 may open up in various possible formats, with control buttons 671 and text fields 672 to match the selected search service. For example, if search is performed on a search engine such as Bing, the control buttons 671 may show options for web search, images, videos, news, etc, and the text fields 672 may show options for keyword search text. Likewise if search is preformed on a video sharing site such as YouTube or on a microblogging service such as Twitter, the control buttons 671 and the text fields 672 may be modified to match the context of the particular search service used.

In one embodiment, the Feed Book Service module 175 is an instance of the Feed Web Service Module 150 that may search for data on a local device, rather than searching for it on an external Web Service. In other words, while performing keyword search on various Feed Web Services may retrieve search results from the network, searching for previously created bookmarks may retrieve search results from computer storage media on the local device or from a private service accessible only to the user of that device.

FIG. 6e shows an example of the Discovery Window 510 according to one embodiment. The Discovery window 510 may consist of the search pane 610, the search results pane 630 and an advertising pane 640. The search results pane 630 may consist of one or more individual search results 631 and the advertising pane 640 may consist of one or more advertisements 641. The advertisement 641 may be in any format relevant to the context of the search, such as, but not limited to, picture, web page, video, animation, game, or any other advertising format.

In one embodiment, the advertisement 641 may be generated from the same search keywords used to generate the search result 631. In another, embodiment, the advertisement 641 may be unrelated to the search result 631; in this case some other rule may be used to decide which advertising result to show as the advertisement 641.

### 4. USER INTERFACE FOR THE PRESENTATION OF WEB CONTENT

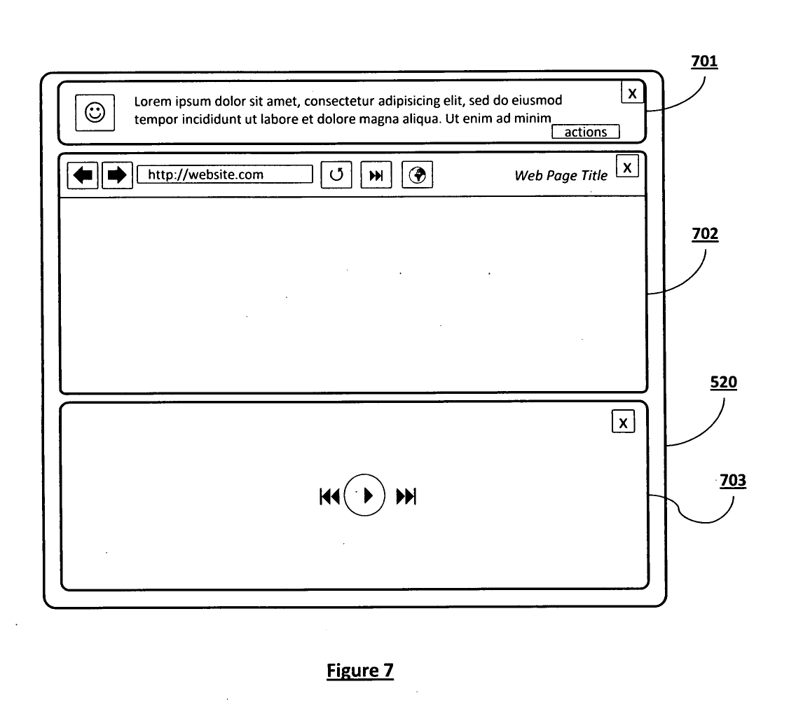

FIG. 7 shows an example of one embodiment of the View window 520 in greater detail. The View window 520 may provide the Resources 180 to display content that a user has selected by selecting the search result 631. Selecting the search result 631 may create a request for content and may place that request for content in form of a message via the View Holder Module 112 on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. One or more Feed Web Service Modules 150 may take the transmuted message from the Message Bus Module 120 and may send it to one or more Feed Web Services. One or more Feed Web Services may respond with one or more results of the request for content. One or more Feed Web Service Modules 150 may place those results in form of messages on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. The View window 520 may take the transmuted messages via the View Holder Module 112 from the Message Bus Module 120 and may display them as results of the keyword search, as described below.

The View window may consist of an annotation pane 701, a web browser pane 702, a video player pane 703, and may also consist of other possible panes for rich Internet programs, such as a pane for Adobe™ Flash™ games, a pane for Silverlight™ programs, a pane for electronic reader programs, and additional panes for other content formats. The View window 520 may display a combination of panes based on the type of content chosen when a user selects the individual search result 631 in the search results pane 630 of the Discovery window 510. The software may recognize the type of content that the user has selected based on the output from the Transmuter Module 130, and the View window 520 may therefore use one or more panes that correspond to the type of content displayed. For example, if the content is a short text message, the View window 520 may use the annotation pane 701 to display the content. If the content is a web page (HTML page), the View window 520 may use the web browser pane 702 to display the content. If the content is a video file, the View window 520 may use the video player pane 703 to display the content. The View window 520 may also use any appropriate combination of windows to display the content, such as the annotation pane 701 and the video player pane 703, or any other combination of panes relevant for the search results.

### 5. USER INTERFACE FOR POSTING TO WEB SERVICES

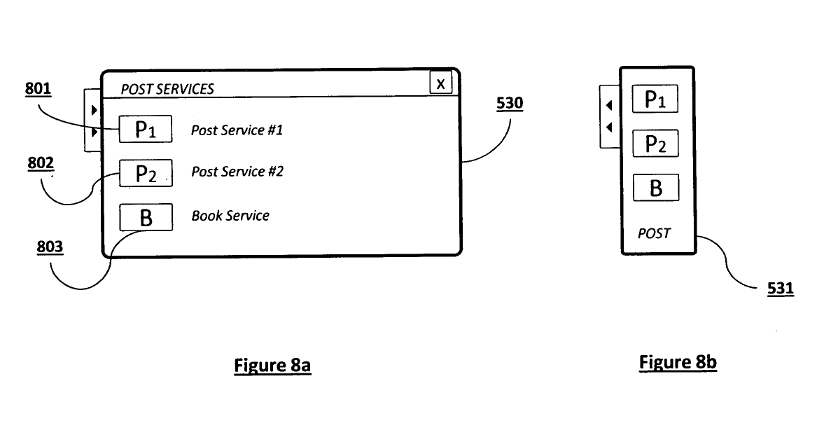

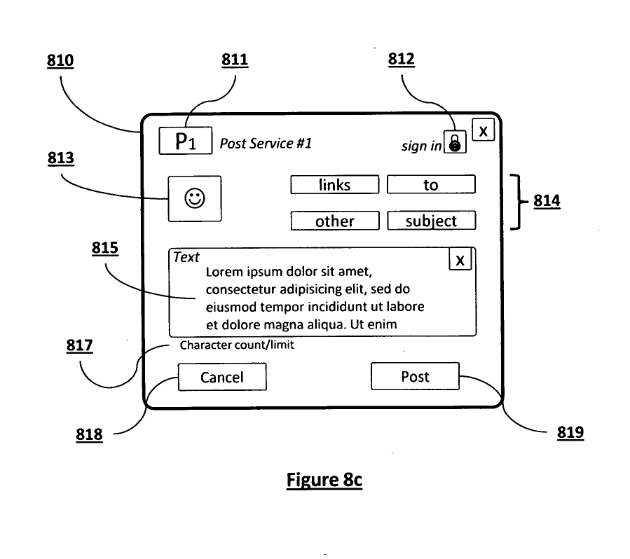

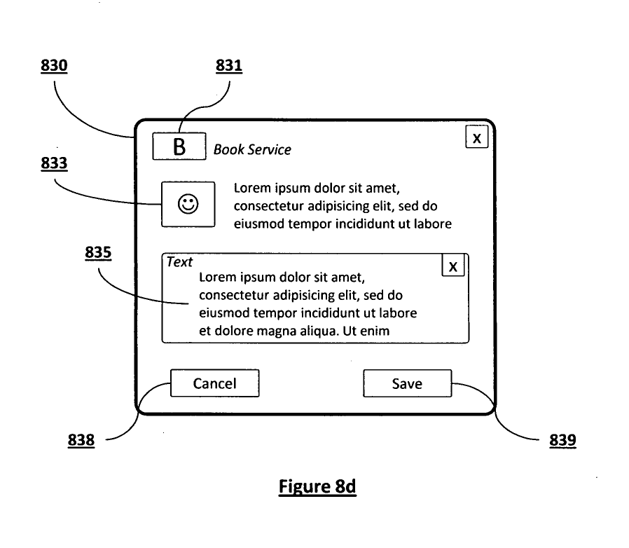

FIG. 8a shows an example of one embodiment of the Post window 530 in greater detail. The Post window 530 may provide controls for a user to compose a command and may place that command in form of a message via the Post Holder Module 113 on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. One or more Post Web Service Modules 160 may take the transmuted message from the Message Bus Module 120 and may send it to one or more Post Web Services. One or more Post Web Services may acknowledge receipt or execution of the command. One or more Post Web Service Modules 160 may place that acknowledgment in form of messages on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. The Post window 530 may take the transmuted messages via the Post Holder Module 113 from the Message Bus Module 120 and may display them as results of the acknowledgment of the receipt or execution of the command, as described below.

In another embodiment, the Post window 530 may provide controls for a user to compose a command and may place that command in form of a message via the Post Holder Module 113 on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. The Post Book Service Module 170 may take the transmuted message from the Message Bus Module 120 and may send it to the Storage Module 140. The Storage Module 140 may acknowledge receipt or execution of the command and may place that acknowledgment in form of messages on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. The Post window 530 may take the transmuted messages via the Post Holder Module 113 from the Message Bus Module 120 and may display them as results of the acknowledgment of the receipt or execution of the command, as described below.

FIG. 8a shows an example of the full view of the Post window 530 according to one embodiment. The Post window 530 may consist of one or more post service control buttons 801-802, and one or more book service control buttons 803. In this example, the post service control button 801 may be associated with one or more Post Web Services #1, the post service control button 802 may be associated with one or more Post Web Services #2, and the book service control button—803 may be associated with a Post Book Service. The Post Web Services are denoted with numbers #1 and #2 here for illustrative purpose only, i.e. to show that they may be different from each other; it will be apparent to anyone skilled in the art that there may be any number of various Post Web Services without departing from the spirit of the instant application. The control buttons 801-803 may allow the user to access the associated services, as described below.

FIG. 8b shows an example of a minimized view of the Post window 531 according to one embodiment, where the service control buttons 801-803 may be shown in their minimized form. Depending on a particular embodiment, either the full view of the Post window 530 or the minimized view of the Post window 531 may be the default view of the Post window.

A user may select the individual search result 631 in the search results pane 630 of the Discovery window 510, and the user may post or bookmark that search result. When the user selects the post service control button 801, a post service pane 810, shown in FIG. 8c, may open.

FIG. 8c shows an example of the post service pane 810 according to one embodiment. The post service pane 810 may consist of a logo button 811 of one or more Post Web Services, a control button 812 used to sign in into that Post Web Service, an icon 813 representing the search result 631, other control buttons 814 that may be relevant for that. Post Web Service (which would vary for different Post Web Services), a text box 815 where the user may type their comments, an information box 817 which may tell the user if there is a limit on the length of comments entered into the text box 815 or other data relevant for that Post Web Service, a cancel control button 818 and a post control button 819. It should be noted that the elements of the post service pane 810 may depend on a particular Post Web Service that the user may choose, and that a different Post Web Service may have different elements associated with its post service pane 810. The elements presented here are for illustrative purposes only; other elements may be used without departing from the spirit of the instant application.

By selecting the control button 812 used to sign in into a particular Post Web Service, a user may be presented with a Sign In window in place of the Post window 530, whereby the user may enter their credentials for accessing that Post Web Service.

A user may select the individual search result 631 in the search results pane 630 of the Discovery window 510, and the user may post or bookmark that search result. If the user clicks on the book service control button 803, a book service pane 830, shown in FIG. 8d, may open.

In one embodiment, the Post Book Service module 170 is an instance of the Post Web Service Module 160 that may save data to computer storage media on a local device, rather than posting it to an external Web Service. In other words, while posting data to various Post Web Services may make this data accessible on the network, bookmarking data may post that data to computer storage media on the local device or to a private service accessible only to the user of that device.

FIG. 8d shows an example of the book service pane 830 according to one embodiment. The book service pane 830 may consist of a bookmark logo button 831, an icon 833 representing the search result 631, a text box 835 where a user may type their comments, a cancel control button 838 and a save control button 839.

### 6. USER INTERFACE FOR MAINTAINING WEB CONTENT IN VIEW

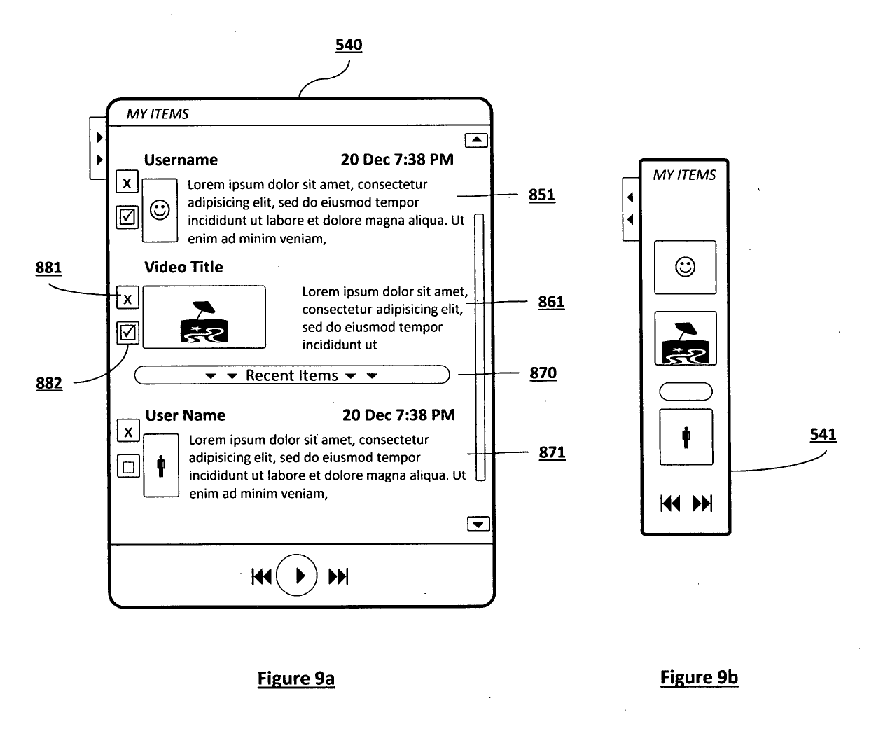

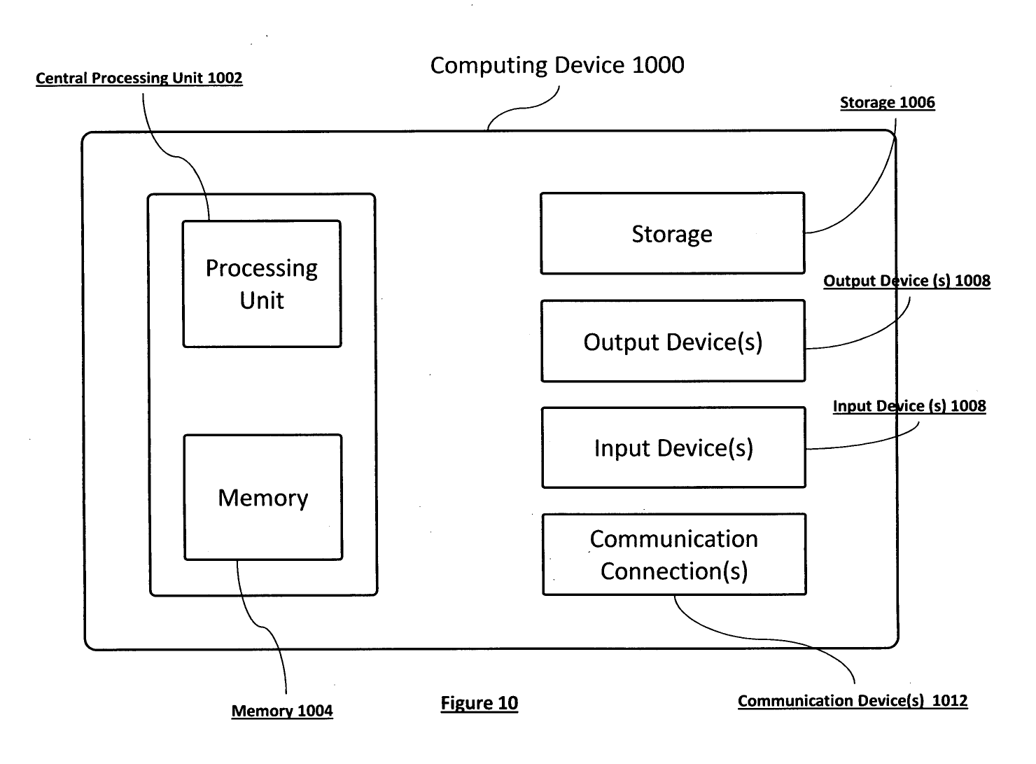

FIG. 9a shows an example of one embodiment of the Ready window 540 in greater detail. The Ready window 540 may provide controls for a user to retrieve one or more previously composed posts and bookmarks and may place those posts or bookmarks in form of messages via the Discovery Holder Module 111 on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. One or more Feed Web Service Modules 150 may take the transmuted message from the Message Bus Module 120 and may send it to one or more Feed Web Services. One or more Feed Web Services may respond with one or more retrieved posts or bookmarks. One or more Feed Web Service Modules 150 may place those posts or bookmarks in form of messages on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. The Ready window 540 may take the transmuted messages via the Discovery Holder Module 111 from the Message Bus Module 120 and may display them as retrieved items, as described below.

In another embodiment, the Ready window 540 may provide controls for a user to retrieve one or more previously composed posts and bookmarks and may place those posts or bookmarks in form of messages via the Discovery Holder Module 111 on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. The Feed Book Service Module 175 may take the transmuted message from the Message Bus Module 120 and send it to the Storage Module 140. The Storage Module 140 may respond with one or more retrieved posts or bookmarks and may place those posts or bookmarks in form of messages on the Message Bus Module 120. The Transmuter Module 130 may monitor the messages traveling across the Message Bus Module 120 and, based on the logic in a chaining rule engine, may optionally intercept, manipulate, or create new messages, or it may convert and adapt data. The Ready window 540 may take the transmuted messages via the Discovery Holder Module 111 from the Message Bus Module 120 and may display them as retrieved posts or bookmarks, as described below.

In one embodiment, the Ready window 540 may consist of one or more posts and one or more bookmarks. A search result 631 that a user posts may become a posted item. A search result 631 that the user bookmarks may become a bookmarked item.

FIG. 9a shows an example of the full view of the Ready window 540 according to one embodiment. The Ready window 540 may consist of a posted item 851, a bookmarked item 861, a list of recent items 870, and one or more recent items 871. The recent item may be a result that has been viewed recently. Every posted, bookmarked and recent item may have an associated delete button 881 and an associated save button 882. Deleting an item may delete it from the Ready window 540, while saving an item may pin it to the Ready window 540.

FIG. 9b shows an example of a minimized view of the Ready window 541 according to one embodiment, where the posted item 851, the bookmarked item 861, the list of recent items 870, and one or more recent items 871 may be shown in their minimized form. Depending on a particular embodiment, either the full view of the Ready window 540 or the minimized view of the Ready window 541 may be the default view of the Ready window.

FIG. 10 illustrates a component diagram of a computing device according to one embodiment. The computing device 1000 may be utilized to implement one or more computing devices, computer processes, or software modules described herein. In one example, the computing device 1000 can be utilized to process calculations, execute instructions, receive and transmit digital signals. In another example, the computing device 1000 may be utilized to process calculations, execute instructions, receive and transmit digital signals, receive and transmit searches, and hypertext, compile computer code as required by a Server 11, 12, 13 or a Client 10. The computing device 1000 may be any general or special purpose computer now known or to become known capable of performing the steps and/or performing the functions described herein, either in software, hardware, firmware, or a combination thereof.

In its most basic configuration, computing device 1000 typically includes at least one central processing unit (CPU) 1002 and memory 1004. Depending on the exact configuration and type of computing device, memory 1004 may be volatile (such as RAM), non-volatile (such as ROM, flash memory, etc.) or some combination of the two. Additionally, computing device 1000 may also have additional features or functionality. For example, computing device 1000 may include multiple CPUs. The described methods may be executed in any manner by any processing unit in computing device 1000. For example, the described process may be executed by both multiple CPUs in parallel.

Computing device 1000 may also include additional storage (removable and/or non-removable) including, but not limited to, magnetic or optical disks or tape. Such additional storage is illustrated in FIG. 10 by storage 1006. Computer storage media includes volatile and nonvolatile, removable and non-removable media implemented in any method or technology for storage of data such as computer readable instructions, data structures, program modules or other data. Memory 1004 and storage 1006 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired data and which can accessed by computing device 1000. Any such computer storage media may be part of computing device 1000.

Computing device 1000 may also contain communications device(s) 1012 that allow the device to communicate with other devices. Communications device(s) 1012 is an example of communication media. Communication media typically embodies computer readable instructions, data structures, program modules or other data in a modulated data signal such as a carrier wave or other transport mechanism and includes any data delivery media. The term “modulated data signal” means a signal that has one or more of its characteristics set or changed in such a manner as to encode data in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 1000 may also have input device(s) 1010 such as keyboard, mouse, pen, voice input device, touch input device, etc. Output device(s) 1008 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the instant application.

### 7. CONCLUSION

The instant application described above provides a way for enabling a user to discover, present, save and share Web content. The user is provided a means of executing searches across Web services, as well as for saving and those searches for later use. An embodiment of the method and system employs the use of the Transmuter to display Web content in a format deemed optimal by the user. Users are also provided a means of saving references to Web content on their device, as well as posting those references along with certain annotations using Web services. While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the instant application.

The foregoing description of various implementations of the instant application has been presented for purposes of illustration and description. It is not exhaustive and does not limit the instant application to the precise structural features and/or methodological steps disclosed. Other embodiments will be apparent to those skilled in the art from consideration of the specification and practice of the instant application disclosed herein. The instant application should therefore not be limited by the above described embodiment, method, and examples, but by all embodiments and methods within the scope and spirit of the instant application.

What is claimed is:

1. A system comprising:
a layout module configured to control the interface between a user and the system's one or more other modules;
a message bus module configured to manage communications of the system;
a transmuter module configured to perform inline manipulation of data transmitted among a plurality of modules;
a storage service module configured to manage the storage of data specific to the system;
one or more feed web service modules that manage interaction with feed web services;
one or more post web service modules that manage interaction with post web services; and
one or more resources that are used to display content and interact with the user.

2. The system of claim 1 wherein the feed web service module searches for data on a local device.

3. The system of claim 1 wherein the post web service module saves data to a local device.

4. The system of claim 1 wherein the feed web service returns search results accessible over a network.

5. The system of claim 1 wherein the post web service is any communication network.

6. The system of claim 1 wherein the transmuter module monitors one or more messages traveling across the message bus module and, based on the logic in a chaining rule engine, if the logic indicates to intercept the messages it will intercept the messages, if the logic indicates to manipulate the messages it will manipulate the messages, if the logic indicates to create new messages it will create the messages, and if the logic indicates not to take any action on the messages it will not take any action on the messages.

7. The system of claim 1 wherein the transmuter module converts and adapts data, redirects messages, and masks the source of the messages.

8. The system of claim 1 wherein:
the feed web service returns search results accessible over a network;
the post web service is any communication network;
the transmuter module monitors one or more messages traveling across the message bus module and, based on the logic in a chaining rule engine, if the logic indicates to intercept the messages it will intercept the messages, if the logic indicates to manipulate the messages it will manipulate the messages, if the logic indicates to create new messages it will create the messages, and if the logic indicates not to take any action on the messages it will not take any action on the messages; and
the transmuter module converts and adapts data, redirects messages, and masks the source of the messages.

9. A computer-readable storage media containing instructions thereon which, when executed, implement a web service element comprising:
a user interface logic component that manages interaction with a user;
a behavior logic component that manages how the software should respond to user requests;
a data structure component that is used to structure the data provided by the user or associated web services; and
a serialization logic component that manages how data related to the associated web services is stored for later retrieval.

10. The computer-readable storage media of claim 9 wherein the web service element interacts with other web service elements and other mechanisms of the system via a message bus module.

11. The computer-readable storage media of claim 9 wherein the behavior logic component consists of a messaging behavior logic component that manages the web service element's communications, a service behavior logic component that implements rules specific to associated web services, and an element behavior logic component that manages the creation and destruction of one or more web service elements.

12. A computer-readable storage media containing instructions thereon which, when executed, implement a user interface comprising:
a discovery window that accepts input for a keyword search, displays results from the keyword search, and accepts input to select results from the keyword search;
a view window that displays content;
a post window that accepts input to compose commands; and
a ready window that accepts input to retrieve items.

13. The computer-readable storage media of claim 12 wherein the discovery window accepts input for a keyword search accessible over a network, displays results from the keyword search accessible over the network, and accepts input to select results from the keyword search accessible over the network.

14. The computer-readable storage media of claim 12 wherein the discovery window accepts input for a keyword search accessible from a local device, displays results from the keyword search accessible from the local device, and accepts input to select results from the keyword search from the local device.

15. The computer-readable storage media of claim 12 wherein the view window displays content accessible over a network.

16. The computer-readable storage media of claim 12 wherein the view window displays content from a local device.

17. The computer-readable storage media of claim 12 wherein the post window accepts input to compose commands executable over a network.

18. The computer-readable storage media of claim 12 wherein the post window accepts input to compose commands executable on a local device.

19. The computer-readable storage media of claim 12 wherein the ready window accepts input to retrieve items accessible over a network.

20. The computer-readable storage media of claim 12 wherein the ready window accepts input to retrieve items from a local device.
